(19) United States
(12) Patent Application Publication
(10) Pub. No.: US 2019/0044657 A1
(43) Pub. Date: Feb. 7, 2019

(54) METHOD AND APPARATUS TO MANAGE UNDERSIZED NETWORK PACKETS IN A MEDIA ACCESS CONTROL (MAC) SUBLAYER

(71) Applicant: Intel Corporation, Santa Clara, CA (US)

(72) Inventors: Daniel Christian Biederman, Saratoga, CA (US); Matthew James Webb, Woodland Hills, CA (US)

(21) Appl. No.: 16/145,844

(22) Filed: Sep. 28, 2018

(51) Int. Cl. H04L 1/00; H04L 12/823; H04L 29/08; H04L 12/851

(52) U.S. Cl. CPC H04L 1/0061; H04L 47/2483; H04L 69/324; H04L 47/32

(57) ABSTRACT

Received undersized Ethernet frames are isolated and discarded in a Media Access Control (MAC) sublayer having a bus width greater than the number of bytes in a received minimum size Ethernet frame. The MAC sublayer maintains one counter to track the total number of undersized frames (undersized frames with good Cyclic Redundancy Check (CRC)) and runts with bad CRC). Undersized Ethernet frames are discarded by the MAC sublayer prior to calculating Cyclic Redundancy Check (CRC) for the Ethernet Frame.

### FIELD

This disclosure relates to network management and in particular to management of undersized network packets.

### BACKGROUND

Bandwidth is the maximum rate of data transfer across a given path. For example, through the use of link aggregation, a number of connections between a source and destination may be aggregated into a single interface so that the bandwidth of a communication link between the source and destination is the sum of the maximum rate of transfer across all of the connections.

Local Area Networks (LANs) and Metropolitan Area Networks (MANs) may use the Institute of Electrical and Electronics Engineers (IEEE) 802.3 (Ethernet) protocol and frame format for data communication. Ethernet protocol uses a common media access control (MAC) sublayer of a data link layer in the Open Systems Interconnection model (OSI model). The OSI model is a conceptual model that partitions a communication system into abstraction layers. The MAC sublayer is responsible for transferring data to and from a Physical Layer and encapsulates frames received from upper layers (for example, frames received from a network layer in the OSI reference model) into frames appropriate for the transmission medium. Speed specific Media Independent Interfaces (MIIs) provide an interface to the physical layer that encodes frames for transmission and decodes received frames with the modulation specified for the speed of operation, transmission medium and supported link length.

The interface between the MAC sublayer and the Physical Layer includes signals for framing and collision detect, and transmit and receive serial bit streams. A basic MAC frame has a minimum length of 64 bytes and a maximum length of 1518 bytes. The basic MAC frame includes Destination Address, Source Address, Length/Type field, MAC Client Data, Pad (if required), and Frame Check Sequence.

The maximum length of an Ethernet frame is 1518 bytes which includes 14 bytes of Ethernet header, 1500 bytes of data and 4 bytes of Frame Check Sequence (FCS). The FCS is a Cyclic Redundancy Check (CRC) over all fields in the Ethernet frame (except the FCS). Between each transmitted frame there are two bytes of Interframe gap and 8 bytes of preamble. Thus, each maximum length Ethernet frame consumes 1538 bytes of the bandwidth.

A lane is a bundle of signals that constitutes a logical subset of a point-to-point interconnect. The copper based Gigabit (Gb) Ethernet Network (1000 BaseT) uses four lanes over all four cable pairs for simultaneous transmission in both directions. The theoretical maximum bandwidth on a Gigabit Ethernet network is defined by a node being able to send 1 Gb (125 Mega Bytes (MB)) each second. Bandwidth of the transmission medium may be increased by transmitting serial data over multiple lanes.

In addition to receiving and transmitting normal frames, the MAC sublayer is also responsible for discarding received malformed frames, which may be referred to as undersized frames or runts (an Ethernet frame that is less than the minimum length of 64 bytes). Runts and undersized frames may be fragments of frame collisions or caused by a malfunctioning network interface controller (NIC).

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram illustrating Ethernet port logic in a network interface controller;

FIG. 2 is a block diagram of receive data path processing logic in the MAC sublayer shown in FIG. 1 for a n-byte wide data bus.

FIG. 3A illustrates Ethernet data frames received on a 256 byte data bus with 2 minimum size 64 byte frames and portions (less than 64 byes) of two other valid (64-Byte or greater) Ethernet frames;

FIG. 3B illustrates a 256 byte data bus with 1 minimum size 64 byte Ethernet frame and a plurality of undersized frames;

FIG. 3C illustrates a 256 byte data bus with a plurality of undersized frames;

FIG. 4 is a block diagram of an embodiment of the Media Independent Interface (MII) Receive Module shown in FIG. 3.

FIG. 5 is a flowgraph for processing of undersized frames shown in FIG. 3 by the Media Independent Interface (MII) Receive Module shown in FIG. 2; and

FIG. 6 is a block diagram of a system that includes receive data path processing logic in a network interface controller.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DESCRIPTION OF EMBODIMENTS

The bandwidth of the transmission medium is increasing, for example 100 Gigabits per second (Gb/s) operation (also called 100 Gigabit Ethernet) included in the Institute of Electrical and Electronics Engineers (IEEE) Standard 802.3-2015 and IEEE 802.3bs-2017 standard increases the bandwidth of the transmission medium to 200 and 400 Gbit/s.

Data is transmitted and received over the transmission medium in serial format by the physical layer. The data is received and transmitted by the MAC sublayer in parallel format (data bus). As the bandwidth of the transmission medium is increased, the MAC must either process the received data faster which requires increasing the system clock frequency or increase the amount of data processed per clock cycle by increasing the width of the data bus.

In a system in which the width of the data bus is greater than the sum of two minimum sized (64-byte) Ethernet packets, the MAC includes support to process two 64 byte packets in parallel per clock cycle and also support to process many undersized and runt packets in parallel per clock cycle.

The processing of each received packet includes verifying that the MAC frame is valid by computing CRC for fields in the Ethernet frame except the FCS and comparing the computed CRC with the CRC in the FCS field. The verification of the CRC is performed to determine if a received packet with less than 64-bytes is a runt (computed CRC is not the same as the CRC in the FCS field) or an undersized packet (computed CRC is the same as the CRC in the FCS field). The MAC sublayer maintains two counters, one to track the number of received runts and the other to count the number of received undersized packets. Both runts and undersized packets are invalid MAC frames and are dropped after the CRC verification has been performed.

In an embodiment, in a MAC sublayer having a bus width greater than the number of bytes in a received minimum Ethernet frame, received undersized Ethernet frames are isolated by detecting SOF/EOF and removed. The MAC sublayer maintains one counter to track the total number of undersized frames (undersized frames with good CRC and runts with bad CRC). Undersized Ethernet frames are discarded by the MAC sublayer prior to calculating Cyclic Redundancy Check (CRC) for the Ethernet Frame.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

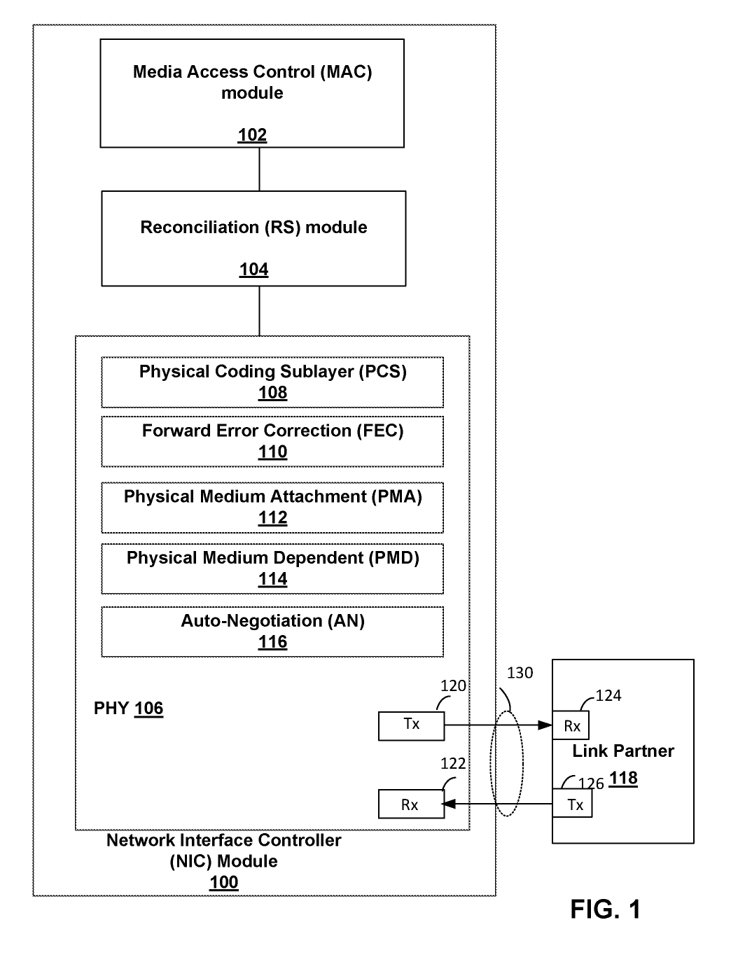

FIG. 1 is a block diagram illustrating Ethernet port logic in a network interface controller module 100. The Ethernet port logic includes a (MAC) module 102, a reconciliation sublayer module 104 and a PHY module 106. The PHY module 106 includes a physical medium dependent (PMD) sublayer module 114, a physical medium attachment (PMA) sublayer module 112, an auto-negotiation (AN) sublayer module 116, a forward error correction (FEC) module 110, a physical coding sublayer (PCS) module 108, a transmitter port 120 including transmitter circuitry and a receive port 122 including receive circuitry. In some embodiments, one or more of the sublayer modules may be incorporated in, or otherwise form a portion of, another sublayer module. For example, part or all of the PMD sublayer module 114, PMA sublayer module 112, the AN sublayer module 116, and/or the FEC module 110 may be incorporated in the PCS module 108.

In the embodiment shown, the Ethernet port has one full-duplex communications lane 130. The communications lane may be a twisted pair conductor, an optical fiber, or an electric backplane connection. For full-duplex operation, the communication lane 130 includes two twisted pair conductors, one pair for transmitting data and the other pair for receiving data from a link partner 118.

MAC module 102 is configured to implement aspects of the MAC layer operations and the RS module 104 is configured to implement reconciliation sublayer operations. During link initialization of communications lane 130 communicatively coupled between network interface controller module 100 and link partner 118, AN sublayer module 116 performs auto-negotiation of link speed and capabilities.

The Physical Medium Dependent (PMD) sublayer module 114 is located just above the Medium Dependent Interface (MDI) and is responsible for interfacing to the transmission medium. The Physical Medium Attachment (PMA) sublayer 112 contains functions for transmission, reception, and collision detection, clock recovery and skew alignment.

The PMD sublayer module 114 and PMA sublayer module 112 are configured to transmit and receive serial binary data over the communication lane and to convert between the serial binary data and parallel data. For example, the PMD sublayer module 114 and PMA sublayer module 112 may receive serial binary data and convert the serial data to 32-bit parallel binary data. The serial to parallel data conversion may be performed by a serializer/de-serializer (SERDES) using, for example, a shift register. Serial data may be transmitted and received over the communications lane 130 at different frequencies.

The AN sublayer module 116 is configured to auto-negotiate line transmission speed, mode of operation, and other communication parameters with a link partner 118 over the communication lane 130. The auto-negotiation (AN) sublayer module 116 may be a state machine or other logic capable of implementing an auto-negotiation protocol. For example, the auto-negotiation (AN) module 116 may implement the auto-negotiation protocol specified by the IEEE 802.3 specification.

The FEC module 110 may decode data passed from the PMD sublayer module 114 and PMA sublayer module 112 to the PCS module 108 and encode data passed from the PCS module 108 to the PMD sublayer module 114 and PMA sublayer module 112. The forward error correction code may improve the reliability of data transmission at higher line speeds.

The PCS module 108 is configured to decode parallel data received from the PMD sublayer module 114 and the PMA sublayer module 112 into decoded parallel data that may be processed by the MAC module 102, and to encode parallel data received from the MAC module 102 into encoded parallel data that may be transmitted by the PMD sublayer module 114 and the PMA sublayer module 112. Data transmitted over the communication lane 130 may be encoded, for example, to improve communication efficiency. For example, encoding the parallel data may add timing or synchronization symbols, align the data, add state transitions to the encoded data to improve clock recovery, or otherwise prepare the encoded data for serial transmission. The PCS module 108 may be capable of encoding or decoding the parallel data using multiple line codes. For example, the PCS module 108 may be capable of using a 64-bit/66-bit line code in which 64-bit blocks of data are encoded into 66-bit blocks of encoded data.

The MAC module 102 is configured to transfer data to and from the PHY module 106. The Reconciliation Sublayer (RS) module 104 is a mapping function that reconciles the signals at the Media Independent Interface (MII) to the Media Access Control (MAC)-Physical Signaling Sublayer (PLS) service definitions.

In the transmit direction, the MAC module 102 receives data to be transmitted in a MAC frame over the communications lane 130, and generates the MAC frame that includes inter-packet gap (IPG), preamble, start of frame delimiter (SFD), padding, and Cyclic Redundancy Check (CRC) bits in addition to the received data before passing the MAC frame to the PHY module 106 over a data bus. The PHY module 106 encodes the MAC frame as required for reliable serial transmission over the communications lane 130 to the link partner 118.

In the receive direction, the MAC module 102 receives MAC frames over a data bus from the PHY module 106. The MAC module 102 accepts MAC frames from the PHY, performs Ethernet frame detection and validation, cyclic redundancy check (CRC) validation, updates statistics counters, strips out the CRC, preamble, and SFD, and forwards the rest of the MAC frame that includes headers for other protocols to a next layer (for example, the Internet protocol (IP) layer).

Between each received Ethernet frame there are two bytes of Interframe gap and eight bytes of preamble. The eight byte preamble consists of a 56-bit (seven-byte) pattern of alternating 1 and 0 bits, providing bit-level synchronization and a one-byte start frame delimiter (SFD). The SFD, preamble or other fields in the frame may be used to identify the beginning of the Ethernet frame, which may also be referred to as Start of Packet (SOP) An embodiment will be described for use of SFD to identify the SOP.

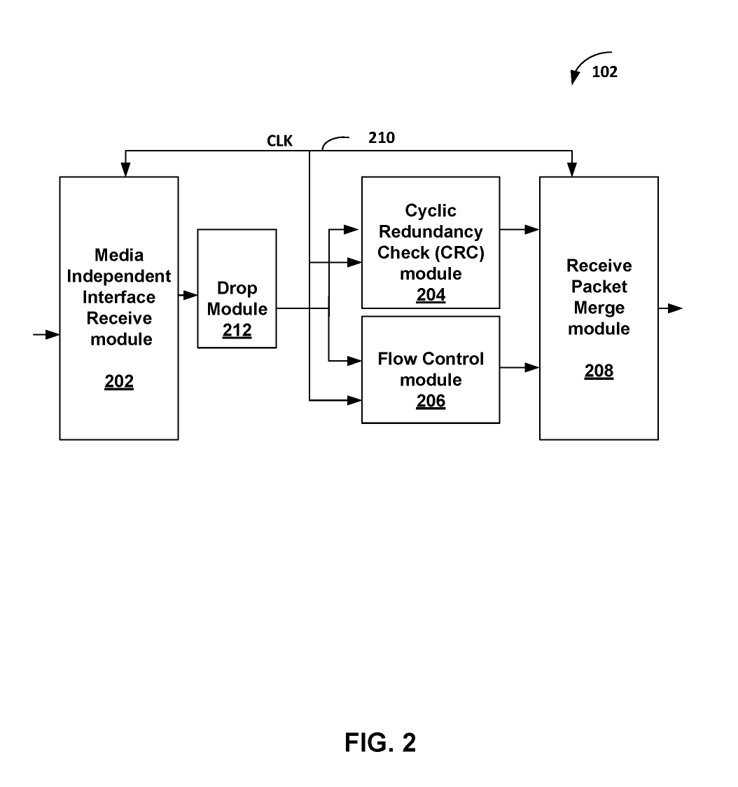

FIG. 2 is a block diagram of receive data path processing logic in the MAC module 102 shown in FIG. 1 for a n-byte wide data bus. An embodiment will be described for n equal to 256. A 256 byte data bus can include 4 minimum size MAC frames (4 64 Byte frames) to be processed in parallel or 3 minimum size MAC frames 3 64 Byte frames) and 2 portions (the other 64 bytes of the 256 byte data bus) of minimum size MAC frames.

As the minimum size MAC frame is 64 Bytes, the 256-byte data path can be divided into a plurality of portions in which there should only be one SFD per portion, if no runts or undersized frames are received. In an embodiment, the 256-Byte data path is divided into 4 64-Byte portions. If a 64-Byte portion of the 256-byte data bus includes more than one SFP, the frame that includes the first SFP is an undersized or runt frame. The undersized or runt frame is dropped (not forwarded to the next layer for processing) and the undersize/runt frame counter is incremented.

A special symbol, typically referred to as the End of Frame (EOF) symbol is transmitted after the MAC frame to identify the end of the frame. If there are two or more EOFs in the same 64-Byte portion, only the data frame prior to the first EOF is a valid data frame and any data received after the first EOF prior to other EOFs in the same 64-Byte portion is identified as either a runt or undersized frame, and discarded. Other fields in the MAC frame, for example, CRC or an “idle” pattern may also be used to identify the end of the MAC frame, which may also be referred to as End of Packet (EOP). An embodiment will be described for use of EOF to identify the EOP.

Frames on the boundary between the 64-Byte portions are evaluated for length, and discarded if the length is less than the minimum size Ethernet frame (64-Bytes) as being undersized or runt frames.

Referring to FIG. 2, the MAC module 102 includes a Media Independent Interface (MII) Receive Module 202, a Channel CRC module 204, a channel flow control module 206, a drop module 212 and a Receive Packet Merge module 208. Each channel has a Channel CRC module 204 and a channel flow control module 206 with Channel CRC module 204 and a channel flow control module 206 each receiving a 64-byte portion of the 256-bytes received per cycle by the Medial Independent Interface (MII) Receive Module 202.

The Media Independent Interface (MII) Receive Module 202, Channel CRC module 204, channel flow control module 206, drop module 212 and Receive Packet Merge module 208 receive a Clock (CLK) 210. In an embodiment, the clock is 800 Mhz to support a raw Ethernet frame rate of 1.6 Tbps with a 256 byte data bus.

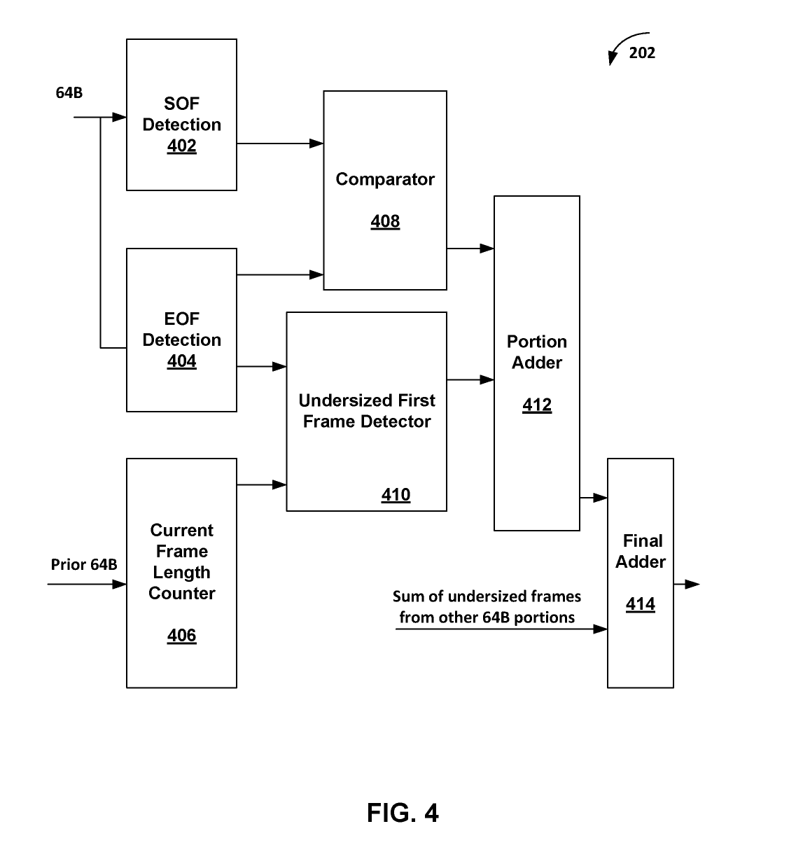

The Media Independent Interface (MII) Receive Module 202 parses the 256 bytes for SOPs and EOPs and maintains a counter that tracks the number of undersized packets detected. The Media Independent Interface (MII) Receive Module 202 will be described in conjunction with FIG. 4. The serial data received from the PHY layer is mapped to a 256 Byte data bus with the first received byte (in the 256-Byte block) represented by byte 255.

For each received packet, the Channel CRC module 204 is configured to perform cyclic redundancy check (CRC) validation and Flow control engine 134 is configured to identify priority flow control packets (for example, a priority code point field in an Ethernet frame that refers to the IEEE 802.1p class of service in an Ethernet frame used to prioritize different classes of traffic over a network) or packets eligible to be dropped (for example, a drop eligible indicator field in an Ethernet frame) that may be used separately or in conjunction with the Priority Code Point field to indicate Ethernet frames eligible to be dropped in the presence of congestion. Receive packet merge module 208 may be configured to merge the packets into separate data streams in the order that they were received

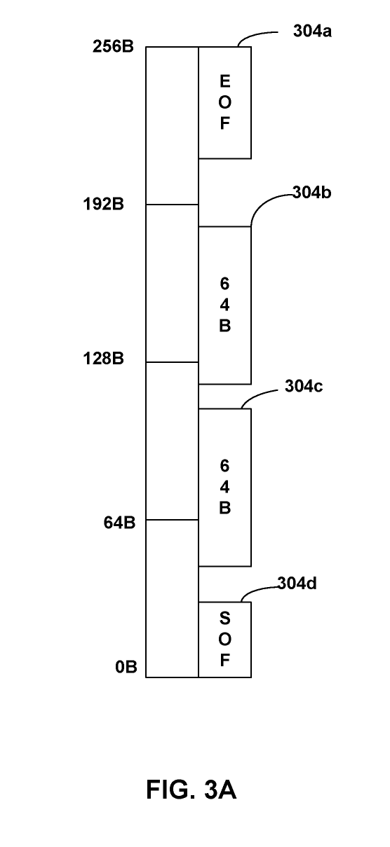

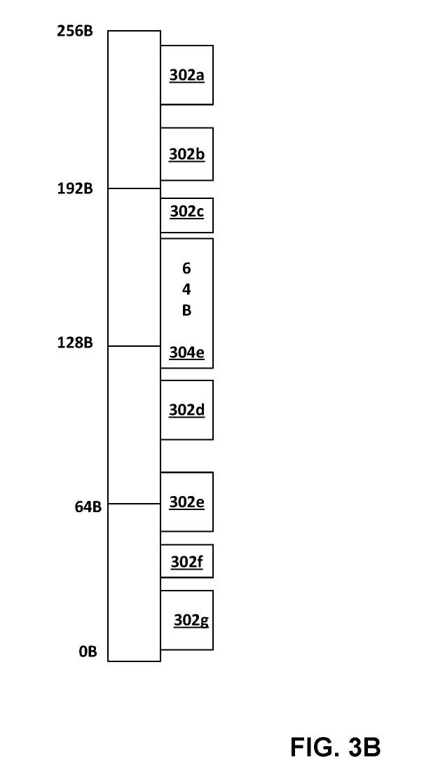

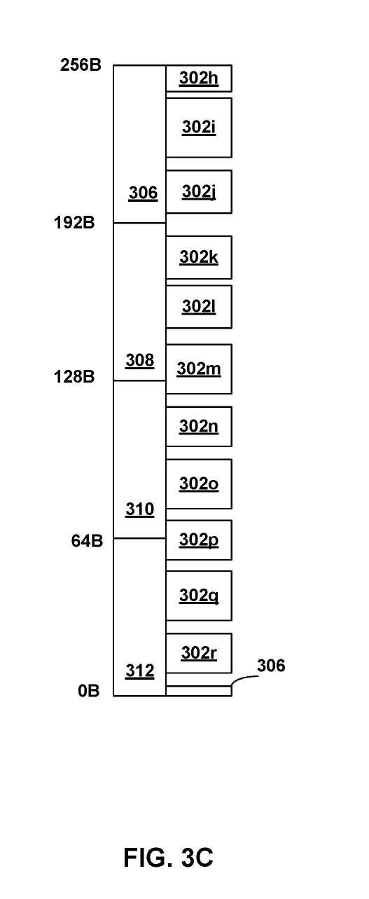

FIG. 3A illustrates Ethernet data frames 304a-d received on a 256 byte data bus with 2 minimum size 64 byte frames 304b, 304c and portions (less than 64 byes) of two other valid (64-Byte or greater) Ethernet frames 304a, 304d. As the figure shows a 256 B (0-255 bytes) bus could have the EOF of one frame 304a, two 64 byte frames 304b, 304c and the start of a fourth Ethernet frame 304d in normal processing.

FIG. 3B illustrates a 256 byte data bus with 1 minimum size 64 byte Ethernet frame 304e and a plurality of undersized frames 302a-302g. The 256-Byte data path has four 64-byte portions, bytes 255:192; 191:128; 127:64; and 63:0. There is one valid 64-byte Ethernet frame 304e and seven undersized/runt frames 302a-302g on the 256-Byte data bus shown in FIG. 3B.

FIG. 3C illustrates a 256 byte data bus with a plurality of undersized frames 302h-302r. The 256 byte data bus also includes the start of another frame which may be a valid (64-Byte or greater) Ethernet frame or an undersized frame which cannot be determined from the portion of the frame on the 256 byte data bus.

A CRC would need to be calculated for each of the undersized frames 302h-302r to determine if the undersized packet is a runt. To calculate CRC for the eleven undersized frames 302h-302r on the 256-byte bus in parallel in a single cycle of the CLK 210 would require at least eleven Channel CRC module 204 units in the Media Independent Interface (MII) Receive Module 202.

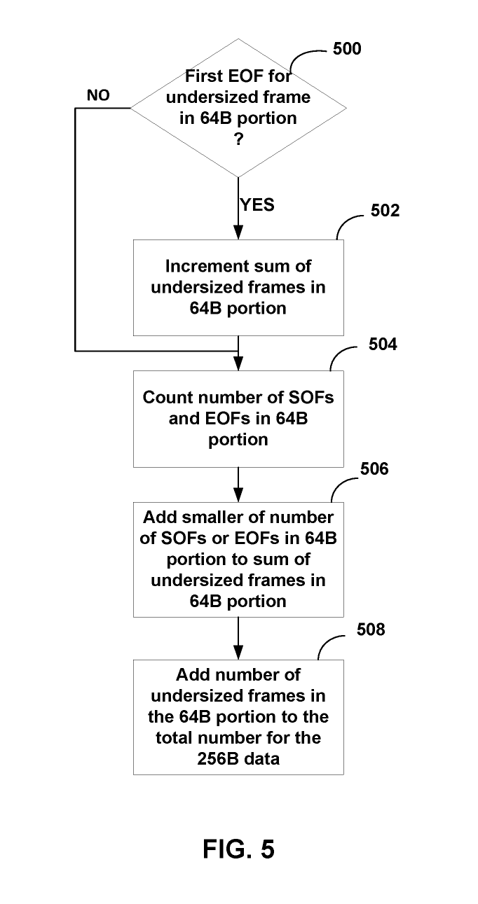

In an embodiment, undersized frames are identified and discarded by drop module 212 prior to calculating CRC in CRC module 204 for received frames. In another embodiment, drop module 212 may be included in the Media Independent Interface (MII) Receive Module 202. Processing of the undersized frames shown in FIG. 3 will be described in conjunction with FIG. 4 and FIG. 5.

FIG. 4 is a block diagram of an embodiment of the Media Independent Interface (MII) Receive Module 202 shown in FIG. 3. The Media Independent Interface (MII) Receive Module 202 includes a SOF detector 402, an EOF detector 404, comparator 408, frame length counter 406, undersized first frame detector 410 and portion adder 412 for each 64-bit portion of the 256-bit data path.

The SOF detector 402 includes a counter that tracks the number of SOFs in the 64-bit portion of the 256-bit data path. The EOF detector 404 includes a counter that tracks the number of EOFs in the 64-bit portion of the 256-bit data path. The frame length counter 406 tracks the number of bytes received for the current frame. The frame length counter 406 also tracks the number of bytes received on the prior 64-bit portion of the 256-bit data path since the last SOF was detected to determine if a frame that spans two 64-bit portions of the 256-bit data path is an undersized frame.

If an EOF is detected prior to an SOF at the beginning of the 64-byte portion, the EOF is for a frame that spans two 64-bit portions of the 256-bit data path. If it is an undersized frame, the sum of undersized frames in adder is incremented in portion adder 412. As SOF and EOF are detected in the 64-bit portion of the 256-bit data path, the count of SOFs and EOFs is incremented in the respective SOF detector 302 and EOF detector 404.

The count of SOFs from the SOF detector 402 and the count of EOFs from the EOF detector 404 for the 64-bit portion of the 256-bit data bus are compared in comparator 408. The number of undersized frames in the 64-bit portion of the 256-bit data bus is the smaller of the two counts (EOF, SOF) and is added to the first undersized packet detected in the 64-bit portion from undersized first frame detector 410.

The sum of undersized frames from portion adder 412 is added to the sum of undersized frames in the other 64-bit portions of the 256-bit data bus in final adder 414. Thus, the total number of undersized frames received is counted instead of distinguishing between runts (bad CRC) and undersized frames (good CRC) to eliminate the need to compute CRC for received undersized frames.

FIG. 5 is a flowgraph for processing of undersized frames shown in FIG. 3 by the Media Independent Interface (MII) Receive Module 202 shown in FIG. 2. FIG. 5 will be described for processing the plurality of undersized frames 302h-302r shown in FIG. 3C and FIG. 4. Each 64 B portion 306, 308, 310, 312 of the 256 B data bus is processed in parallel.

Referring to FIG. 3C, the first 64-byte portion 306 of the 256-byte data bus has three undersized frames 302h, 302i, 302j.

At block 500, the first EOF for undersized frame 302h is detected by EOF detector 304, the undersized first frame detector 410 detects undersized frame 302h based on the count stored in the frame length counter 406. Processing continues with block 502.

At block 502, the sum of undersized frames in the first 64-byte portion 306 that is stored in portion adder 312 is incremented. Processing continues with block 504.

At block 504, the SOF detector 402 detects the SOFs in undersized frames 302h, 302i, 302j and the EOF detector 404 detects the EOFs in undersized frames 302i, 302j. Processing continues with block 506.

At block 506, the number of EOFs and number of SOFs for the first 64-bit portion 306 are compared, as the first EOF for undersized frame 302h was counted at block 500, the number of SOFs is 3 and the number of EOFs is 2, the smaller number, 2 is added to the EOF already stored in portion adder 312.

At block 508, the number of undersized frames in the first 64 B portion 306 is added in final adder 314.

Referring to FIG. 3C, the second 64-byte portion 308 of the 256-byte data bus has three undersized frames 302k, 302l, 302m.

At block 500, the first EOF for undersized frame 302k is detected by EOF detector 304, the undersized first frame detector 410 detects undersized frame 302k based on the count stored in the frame length counter 406. Processing continues with block 502.

At block 502, the sum of undersized frames in the second 64-byte portion 308 that is stored in portion adder 312 is incremented. Processing continues with block 504.

At block 504, the SOF detector 302 detects the SOFs in undersized frames 302k, 302l, 302m and the EOF detector 304 detects the EOFs in undersized frame 302l. Processing continues with block 506.

At block 506, the number of EOFs and number of SOFs for the second 64-bit portion are compared, as the first EOF for undersized frame 302h was counted at block 500, the number of SOFs is 3 and the number of EOFs is 1, the smaller number, 1 is added to the EOF already stored in portion adder 312.

At block 508, the number of undersized frames in the second 64 B portion 308 is added in final adder 314.

Referring to FIG. 3C, the third 64-byte portion 310 of the 256-byte data bus has three undersized frames 302n, 302o, 302p.

At block 500, the first EOF for undersized frame 302h that spans the second 64 B portion 308 and the third 64 B portion 310 is detected by EOF detector 304, the undersized first frame detector 410 detects undersized frame 302m based on the count stored in the frame length counter 406. Processing continues with block 502.

At block 502, the sum of undersized frames in the third 64-byte portion 310 that is stored in portion adder 312 is incremented. Processing continues with block 504.

At block 504, the SOF detector 302 detects the SOFs in undersized frames 302n, 302o, 302p and the EOF detector 304 detects the EOFs in undersized frames 302n, 302o. Processing continues with block 506.

At block 506, the number of EOFs and number of SOFs for the 64-bit portion are compared, as the first EOF for undersized frame 302m was counted at block 500, the number of SOFs is 3 and the number of EOFs is 2, the smaller number, 2 is added to the first EOF already stored in portion adder 312.

At block 508, the number of undersized frames in the 64 B portion is added in final adder 314.

Referring to FIG. 3C, the fourth 64-byte portion 312 of the 256-byte data bus has three undersized frames 302p, 302q, 302r.

At block 500, the first EOF for undersized frame 302p is detected by EOF detector 304, the undersized first frame detector 410 detects undersized frame 302p based on the count stored in the frame length counter 406. Processing continues with block 502.

At block 502, the sum of undersized frames in the fourth 64-byte portion 3 that is stored in portion adder 312 is incremented. Processing continues with block 504.

At block 504, the SOF detector 302 detects the SOFs in undersized frames 302q and 302r and the EOF detector 304 detects the EOFs in undersized frames 302q and 302r. Processing continues with block 506.

At block 506, the number of EOFs and number of SOFs for the 64-bit portion are compared, as the first EOF for undersized frame 302p was counted at block 500, the number of SOFs is 2 and the number of EOFs is 2, 2 is added to the EOF already stored in portion adder 312.

At block 508, the number of undersized frames in the fourth 64 B portion 312 is added in final adder 314.

In the worst case on a 256 Byte bus divided by 64 Byte portions (regions) 306, 308, 310, 312 as shown in FIG. 3C, there are a maximum of four “too small” boundary decisions made in a single clock cycle.

An embodiment has been described for identifying runt and undersized MAC frames in the MAC module 102 (FIG. 1). Runt and undersized MAC frames may be identified in other layers of the protocol stack prior to the MAC module 102. For example, the PCS module 108 (FIG. 1) may identify bit patterns representing start of packet and end of packet and remove undersized frames and runts prior to the MAC module 102, for example, by replacing the undersized frame or runt with “idle” patterns which are sent when there is no data to be transmitted.

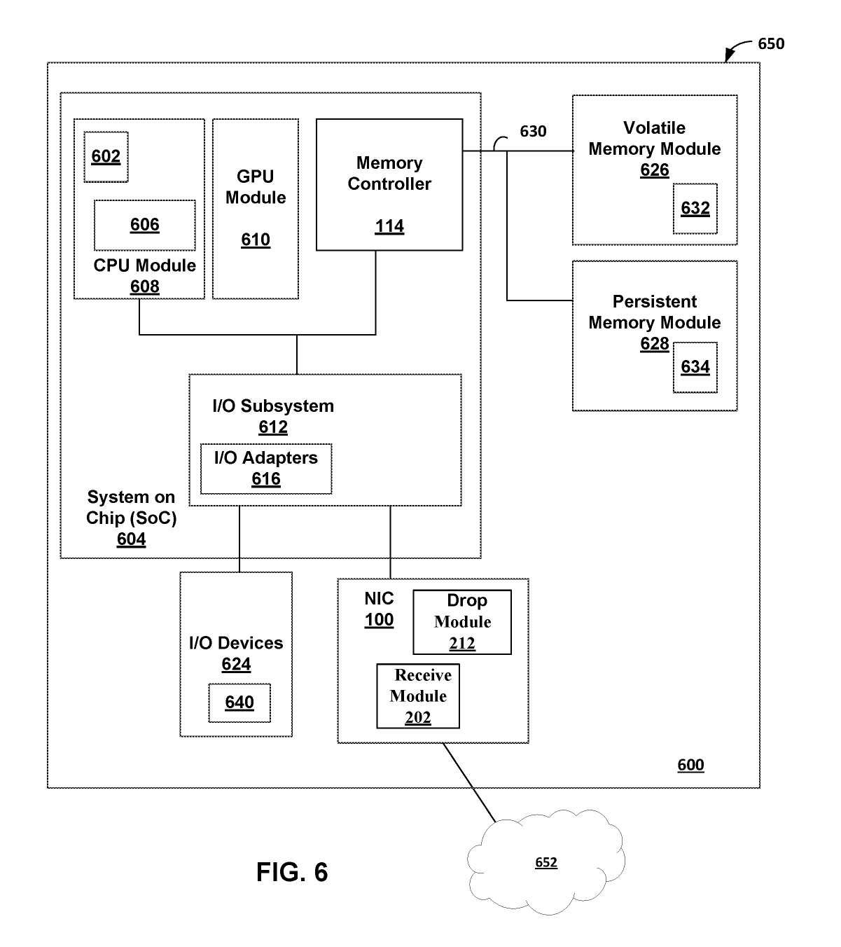

FIG. 6 is a block diagram of a system that includes receive data path processing logic 202 in a network interface controller module 100. System 600 includes a system on chip (SOC or SoC) 604 which combines processor, graphics, memory, and Input/Output (I/O) control logic into one SoC package. The I/O adapters 616 may include a Peripheral Component Interconnect Express (PCIe) adapter that is communicatively coupled over bus 644 to a network interface controller module 100. Drop module 212 in the network interface controller 636 to isolate and remove undersized Ethernet frames prior to verification of CRC and Receive data path processing logic 202 in the network interface controller 636 to maintain one counter to track the total number of undersized frames.

The SoC 604 includes at least one Central Processing Unit (CPU) module 608, a memory controller 614, and a Graphics Processor Unit (GPU) module 610. In other embodiments, the memory controller 614 may be external to the SoC 604. The CPU module 608 includes at least one processor core 602 and a level 2 (L2) cache 606.

Although not shown, the processor core 602 may internally include one or more instruction/data caches (L1 cache), execution units, prefetch buffers, instruction queues, branch address calculation units, instruction decoders, floating point units, retirement units, etc. The CPU module 608 may correspond to a single core or a multi-core general purpose processor, such as those provided by Intel® Corporation, according to one embodiment. In an embodiment the SoC 604 may be an Intel® Xeon® Scalable Processor (SP) or an Intel® Xeon® data center (D) SoC.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5, currently in discussion by JEDEC), LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

The Graphics Processor Unit (GPU) module 610 may include one or more GPU cores and a GPU cache which may store graphics related data for the GPU core. The GPU core may internally include one or more execution units and one or more instruction and data caches. Additionally, the Graphics Processor Unit (GPU) module 610 may contain other graphics logic units that are not shown in FIG. 1, such as one or more vertex processing units, rasterization units, media processing units, and codecs.

Within the I/O subsystem 612, one or more I/O adapter(s) 616 are present to translate a host communication protocol utilized within the processor core(s) 602 to a protocol compatible with particular I/O devices. Some of the protocols that I/O adapter(s) 616 may be utilized for translation include Peripheral Component Interconnect (PCI)-Express (PCIe); Universal Serial Bus (USB); Serial Advanced Technology attachment (SATA) and Institute of Electrical and Electronics Engineers (IEEE) 1594 “Firewire”.

The I/O adapter(s) 616 may communicate with external I/O devices 624 which may include, for example, user interface device(s) including a display and/or a touchscreen display 640, printer, keypad, keyboard, communication logic, wired and/or wireless, storage device(s) including hard disk drives (“HDD”), solid-state drives (“SSD”) 618, removable storage media, Digital Video Disk (DVD) drive, Compact Disk (CD) drive, Redundant Array of Independent Disks (RAID), tape drive or other storage device. The storage devices may be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)).

Additionally, there may be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

It is envisioned that aspects of the embodiments herein may be implemented in various types of computing and networking equipment, such as switches, routers and blade servers such as those employed in a data center and/or server farm environment. Typically, the servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers.

Each blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board. These components may include the components discussed earlier in conjunction with FIG. 8.

An embodiment has been described for a 1.6 Tera bits per second (Tbps) raw Ethernet speed with a bus width of 256 B and the maximum number of frames to be processed per clock cycle is four (that is, four minimum sized 64 B frames). Table 1 below provides examples of data bus width and maximum number of frames per clock cycle for other raw Ethernet speeds.

TABLE 1

| | Maximum number | |
|---|---|---|
| | of legal 64 B frames | |
| Raw Speed | per clock cycle | Bus width |
| 1.6 Tbps | 4 | 256 B |
| 800 Gbps | 3 | 128 B |
| 400 Gbps | 2 | 64 B |
| 200 Gbps | 2 | 32 B |
| 100 Gbps | 1 | 16 B |

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. An apparatus comprising:
media access control circuitry to process a plurality of frames received from a network, the plurality of frames to be received over a N-bit data bus, the media access control circuitry to verify a cyclic redundancy check in a received frame if a number of bytes in the received frame is at least M, wherein M is a minimum number of bytes for a valid frame.

2. The apparatus of claim 1 wherein the media access control circuitry further comprising:
a counter to track received frames with less than M bytes.

3. The apparatus of claim 1, wherein the counter to track received frames with less than M bytes with a valid cyclic redundancy check and received frames with less than M bytes with an invalid cyclic redundancy check.

4. The apparatus of claim 1, wherein the media access controller circuitry to drop a received frame with less than M bytes prior to verification of the cyclic redundancy check for the received frame.

5. The apparatus of claim 1, wherein M is 64 and N is 256.

6. The apparatus of claim 2, wherein the received frame with less than M bytes has a valid cyclic redundancy check.

7. The apparatus of claim 2, wherein the received frame with less than M bytes has an invalid cyclic redundancy check.

8. A method comprising:
receiving a plurality of frames from a network;
processing, by media access control circuitry, the plurality of frames received on a N-bit data bus; and
verifying, by the media access control circuitry, a cyclic redundancy check (CRC) in a received frame if a number of bytes in the received frame is at least M, wherein M is a minimum number of bytes for a valid frame.

9. The method of claim 8 further comprising:
tracking, by the media access control circuitry, a number of received frames with less than M bytes.

10. The method of claim 9, wherein the media access control circuitry to track received frames with less than M bytes with a valid cyclic redundancy check and received frames with less than M bytes with an invalid cyclic redundancy check.

11. The method of claim 8, further comprising:
dropping, by the media access control circuitry, a received frame with less than M bytes prior to verification of CRC for the received frame.

12. The method of claim 8, wherein M is 64 and N is 256.

13. The method of claim 9, wherein the received frame with less than M bytes has a valid cyclic redundancy check.

14. The method of claim 9, wherein the received frame with less than M bytes has an invalid cyclic redundancy check.

15. A system comprising:
Physical Layer circuitry, including, a receiver port including receiver circuitry for one or more lanes to receive a plurality of frames from a network; and
media access control circuitry communicatively coupled to the Physical Layer circuitry, to process the plurality of frames received from the network, the plurality of frames to be received over a N-bit data bus, the media access control circuitry to verify a cyclic redundancy check in a received frame if a number of bytes in the received frame is at least M, wherein M is a minimum number of bytes for a valid frame.

16. The system of claim 15, wherein the media access control circuitry further comprising:
a counter to track received frames with less than M bytes.

17. The system of claim 16, wherein the counter to track received frames with less than M bytes with a valid cyclic redundancy check and received frames with less than M bytes with an invalid cyclic redundancy check.

18. The system of claim 15, wherein the media access controller circuitry to drop a received frame with less than M bytes prior to verification of the cyclic redundancy check for the received frame.

19. The system of claim 15, wherein M is 64 and N is 256.

20. The system of claim 16, wherein the received frame with less than M bytes has a valid cyclic redundancy check.

21. The system of claim 16, wherein the received frame with less than M bytes has an invalid cyclic redundancy check.
